(19) United States
(12) Patent Application Publication
(10) Pub. No.: US 2017/0158147 A1
(43) Pub. Date: Jun. 8, 2017

(54) HITCH BALL MOUNT STORAGE DEVICE

(71) Applicant: BRITTON HARRISON, MESQUITE, NV (US)

(72) Inventor: BRITTON HARRISON, MESQUITE, NV (US)

(21) Appl. No.: 15/141,640

(22) Filed: Apr. 28, 2016

Related U.S. Application Data
(60) Provisional application No. 62/262,455, filed on Dec. 3, 2015.

(51) Int. Cl. B60R 11/06

(52) U.S. Cl. CPC B60R 11/06; B60R 2011/0075

(57) ABSTRACT

A ball mount storage device has a first receiver having four side walls and an open top for receiving the shaft of a ball mount. A plate couples the first receiver to a second receiver. Like the first receiver, the second receiver has four side walls and an open top for receiving the shaft of a ball mount. The ball mount storage device is mountable to a vehicle or a structure.

### CROSS-REFERENCE TO RELATED APPLICATIONS

This application claims the benefit of U.S. Provisional Application Ser. No. 62/262,455, filed on Dec. 3, 2015, which is incorporated herein by reference.

### TECHNICAL FIELD

The present disclosure relates to truck hitches. More particularly, the current disclosure relates to a device for storing ball mounts and other hitches within a vehicle when not in use.

### BACKGROUND

Every owner of a vehicle with a tow hitch system has a common problem: where to store the ball mount when not in use. Some users leave the ball mount connected to the receiver. However, this leaves the ball mount easily visible and thereby more susceptible to theft. Furthermore, this does not solve the issue for a user having multiple ball mounts, such as for varying sizes of balls. Some users place the unused ball mounts in the back of their truck (or trunk of a car), but the ball mount continues to slide around, which is undesirous not only because it's loud, but because it can damage the vehicle and any cargo that it may be carrying. Therefore, there remains a need for a method of easily storing ball mounts that not only helps keep them out of sight, but prohibits them from moving around the vehicle when not in use. The current disclosure seeks to solve these and other problems.

### SUMMARY OF EXAMPLE EMBODIMENTS

In one embodiment, a ball mount storage device comprises a first receiver having four side walls and an open top for receiving the shaft of a ball mount. A front plate couples the first receiver to a second receiver. Like the first receiver, the second receiver likewise comprises an four side walls and open top for receiving the shaft of a ball mount.

In one embodiment, at least one receiver has an aperture aligned with the locking pin aperture of the shaft of the ball mount so that a locking mechanism may be used to prevent theft or other unwanted removal of the ball mount when inserted within the ball mount storage device.

### BRIEF DESCRIPTION OF THE DRAWINGS

FIG. 1 is a perspective view of a hitch ball mount storage device;

FIG. 2 is a front elevation view of a hitch ball mount storage device;

FIG. 3 is a left-side elevation view of a hitch ball mount storage device;

FIG. 4 is a right-side elevation view of a hitch ball mount storage device;

FIG. 5 is a back elevation view of a hitch ball mount storage device;

FIG. 6 is a top plan view of a hitch ball mount storage device; and

FIG. 7 is a bottom plan view of a hitch ball mount storage device.

### DETAILED DESCRIPTION OF EXAMPLE EMBODIMENTS

The following descriptions depict only example embodiments and are not to be considered limiting of its scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to any included drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to another need not imply that each embodiment has similar parts, although it may.

Accordingly, the particular arrangements disclosed are meant to be illustrative only and not limiting as to the scope of the invention. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

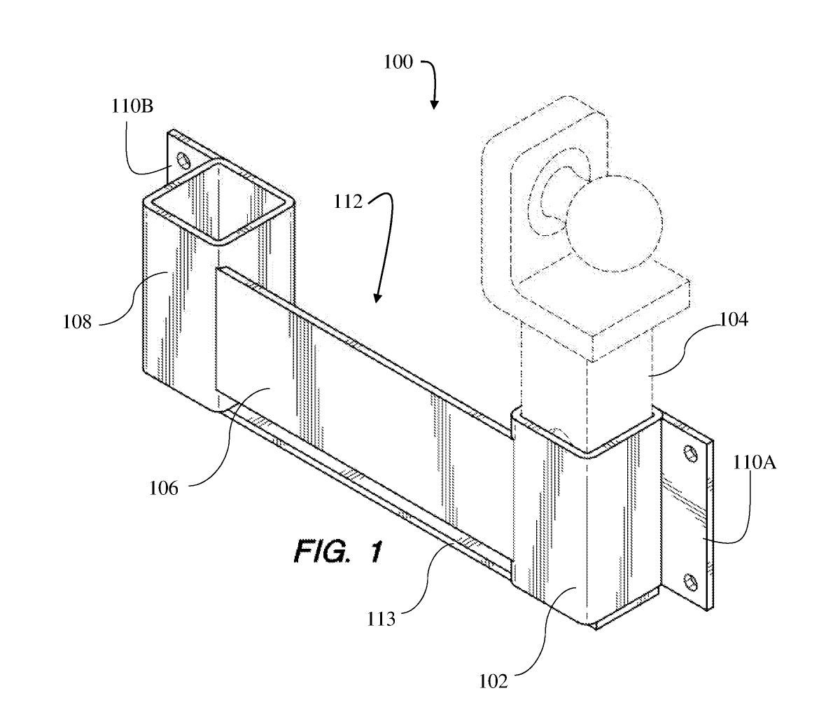

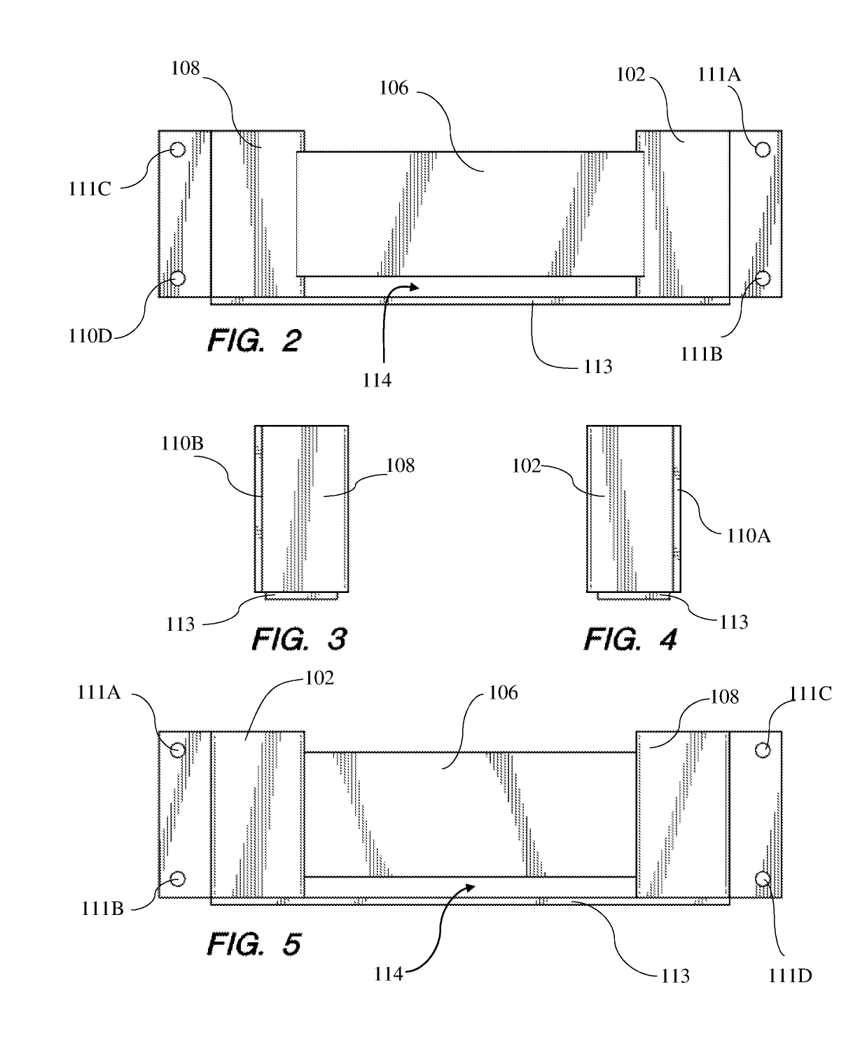

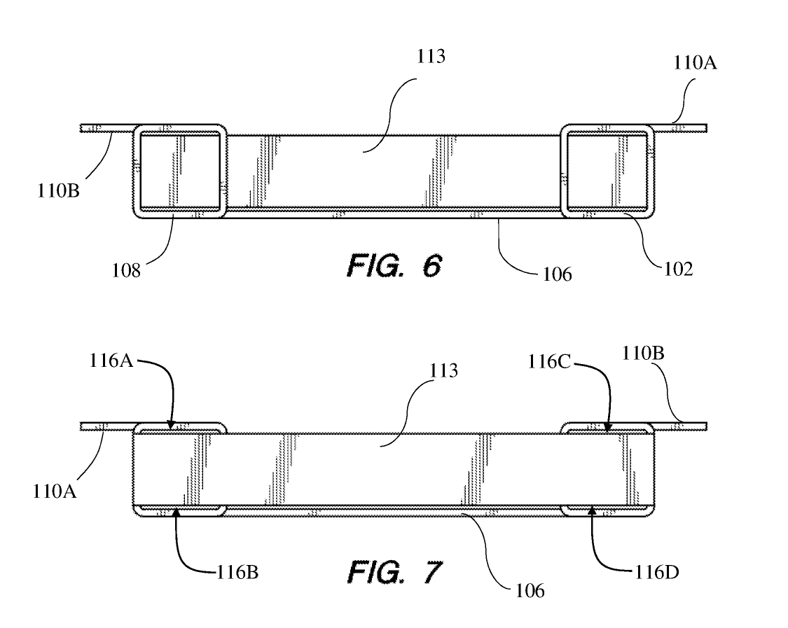

In one embodiment, as shown in FIGS. 1-7, a ball mount storage device 100 comprises a first receiver 102 having four side walls and an open top for receiving the shaft 104 of a ball mount. A front plate 106 (or other member) couples the first receiver 102 to a second receiver 108. Like the first receiver 102, the second receiver 108 likewise comprises four side walls and an open top for receiving the shaft 104 of a ball mount. The front plate 106 may be welded, bolted, molded, or otherwise fastened to each receiver 102, 108. Each receiver 102, 108 has a flange 110A, 110B, respectively, for bolting or otherwise fastening the ball mount storage device 100 to the side of a vehicle (or to the wall of a garage). For example, the flanges may have one or more apertures 111A-D (see FIG. 2) for receiving a screw, bolt, or other fastening device. When flanges 110A, 110B are fastened, a storage gap or space 112 is formed between the front plate 106 and the surface of the car or wall, with a base plate 113 for the bottom. This storage space 112 is useful for storing additional items, such as locking pins, cotter pins, bolts, chains, or other items. To prevent moisture from collecting and causing rust on the ball mount storage device 100 or the items therein, drainage apertures 114 (as best seen in FIGS. 2 & 3) and 116A-D (FIG. 7) are provided along the bottom thereof. It will be appreciated that while numerous drainage apertures are shown, they are not required. Further, rather than gaps on the side of the base plate 113 creating the drainage apertures 114, the base plate 113 may cover the entire bottom of each receiver 102, 108. In such an arrangement, one or more drainage apertures could be added by drilling holes through the base plate or similar. It will be appreciated that there are numerous ways to allow the drainage of moisture therefrom.

The ball mount storage device 100 may be made from metal, plastic, carbon fiber, or any other suitably strong and rigid material. Likewise, while the flanges 110A, 110B are shown as welded to each receiver 102 and 108, they may be bolted or made as an item of single manufacture.

Further, while two receivers 102, 108 are shown, the invention is not so limited and may comprise only one receiver, or may likewise comprise two or more receivers. Further, each receiver 102, 108 need not be the same in size. Hitch shafts may be of varying sizes (e.g., bicycle hitch shafts versus standard trailer hitch shafts) and the receivers 102, 108 of the ball mount storage device 100 may likewise be of varying sizes and widths so as to accommodate such hitches. If the ball mount storage device only comprises one receiver, it will be appreciated that the front plate 106 would be omitted. Further, if a base plate 113 is included, it may be sized so as to fit the width of the receiver. It will be noted that while base plate 113 is illustrated in the drawings and referenced herein, base plate 113 is not required. In other words, the bottom of each receiver 102, 108 may be left open. Therefore, in one embodiment, a ball mount storage device would comprise a receiver having four side walls and an open top for receiving the shaft of a ball mount, and at least one flange for mounting to a vehicle, wall, or other surface.

In one embodiment, not shown, one or more receivers of a ball mount storage device may have at least two locking pin apertures that align with the locking pin apertures of the ball mount hitch shaft. This helps prevent unwanted removal and theft when the ball mount is stored in the ball mount storage device. For example, a user may place the ball mount shaft within a receiver, being sure to align the apertures in the receiver with the apertures in the shaft. Once the apertures are aligned, a user may then insert a locking pin with an associated padlock (or other locking mechanism) to prevent unwanted withdrawal of the ball mount from within the ball mount storage device.

What is claimed is:

1. A ball mount storage device, comprising:
a receiver having four side walls and an open top for receiving the shaft of a ball mount;
a base plate coupled to the bottom of the receiver; and
at least one flange extending from the side of the receiver for fastening the ball mount storage device to a surface.

2. The ball mount storage device of claim 1, further comprising at least two locking pin apertures.

3. The ball mount storage device of claim 1, further comprising one or more drainage apertures.

4. The ball mount storage device of claim 1, further comprising a second receiver coupled to the first receiver by a front plate.

5. The ball mount storage device of claim 4, wherein the base plate extends from the first receiver to the second receiver.

6. A ball mount storage device, comprising:
at least two receivers, each receiver having four side walls and an open top for receiving the shaft of a ball mount;
a front plate that couples the at least two receivers to one another; and
a flange extending from the side of each receiver for fastening to a surface.

7. The ball mount storage device of claim 6, further comprising at least two locking pin apertures in at least one receiver.

8. The ball mount storage device of claim 6, further comprising a base plate extending between the receivers.

9. The ball mount storage device of claim 6, further comprising one or more moisture drainage apertures.
